(19) United States
(12) Patent Application Publication
(10) Pub. No.: US 2016/0219549 A1
(43) Pub. Date: Jul. 28, 2016

(54) SYSTEMS, METHODS, AND DEVICES FOR INDOOR POSITIONING USING Wi-Fi

(71) Applicant: Intel Corporation, Santa Clara, CA (US)

(72) Inventors: Wendy C. Wong, San Jose, CA (US); Qinghua Li, San Ramon, CA (US); Xintian E. Lin, Mountain View, CA (US)

(21) Appl. No.: 14/603,063

(22) Filed: Jan. 22, 2015

(51) Int. Cl. H04W 64/00; G01S 5/14

(52) U.S. Cl. CPC H04W 64/00; G01S 5/145

(57) ABSTRACT

Example systems, methods, and devices for identifying location of wireless communication device are disclosed. In an example embodiment, the device may be configured to transmit GPS coordinates to one or more Wi-Fi access points, measure distance between the wireless communication device and three or more Wi-Fi access points using a ranging technique, and determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points Methods, apparatus, and systems described herein can be applied to 802.11ax or any other wireless standard.

### TECHNICAL FIELD

Example embodiments disclosed generally relate to wireless networks.

### BACKGROUND

There are many devices today that utilize the global positioning system (GPS). GPS is based on a constellation of twenty-four satellites orbiting around the earth that broadcast precise data signals. A single GPS receiver is capable of receiving these signals and can calculate its position (latitude and longitude), altitude, velocity, heading and precise time of day using data signals from at least four GPS satellites. Thus, these GPS receivers can locate themselves anywhere on the planet where a direct view of the GPS satellites is available.

Each satellite transmits two signals, an L1 signal and an L2 signal. The L1 signal is modulated with two pseudo-random noise codes, the protected code and the course/acquisition (C/A) code. Each satellite has its own unique pseudo-random noise code. Civilian navigation receivers only use the C/A code on the L1 frequency. In a positioning device that utilizes the GPS, a GPS receiver measures the time required for the signal to travel from the satellite to the receiver. This done by the GPS receiver generating a replica of the pseudo-random noise code transmitted by the satellite and precisely synchronizing the two codes to determine how long the satellite's code took to reach the GPS receiver. This process is carried out with at least four satellites so that any error in the calculation of position and time is minimized.

A positioning device utilizing GPS is an effective tool in finding a location or determining a position. However, a device utilizing GPS has many limitations. One significant limitation is that GPS is generally unsuitable for indoor positioning applications since a direct view of the GPS satellites is not available. Therefore, it is desirable to have an independent positioning system utilizing technology other than the GPS or working in conjunction with GPS that is functional indoors and in other locations where GPS is not functional.

### BRIEF DESCRIPTION OF THE DRAWINGS

FIG. 1 is a network diagram illustrating an example network environment, according to one or more example embodiments;

FIG. 2 illustrates a plurality of network elements and a mobile device in a Wi-Fi network, according to one or more example embodiments;

FIG. 3 illustrates communication between landmark network elements and a mobile device for position and navigation, according to one or more example embodiments;

FIG. 4 illustrates signal transversal propagation delay in a Wi-Fi network, according to one or more example embodiments;

FIG. 5 illustrates geometric relations between multiple access points, according to one or more example embodiments;

FIG. 6 illustrates example operations in a method for use in systems and devices, according to one or more example embodiments;

FIG. 7 illustrates example operations in a method for use in systems and devices, according to one or more example embodiments;

FIG. 8 illustrates a functional diagram of an example communication station or example access point, according to one or more example embodiments; and

FIG. 9 shows a block diagram of an example of a machine upon which any of one or more techniques (e.g., methods) according to one or more embodiments discussed herein may be performed.

### DETAILED DESCRIPTION

The Wi-Fi alliance is currently developing two different certifications which make use of IEEE 802.11 Fine Timing Measurement (FTM) procedure: (1) Wi-Fi location certification addressing indoor location and indoor navigation as part of the wireless network management (WNM) set of capabilities, and (2) neighbor aware networking (NAN) certification addressing low power device and service discovery over Wi-Fi. Example embodiments of the disclosure relate to systems, method, and devices for indoor position using Wi-Fi so a client device can locate itself by measuring range to multiple access points (APs) with a known location deployed over multiple operating channels.

Additionally, there has been rising interest in indoor positioning in large commercial buildings using WiFi APs since GPS or cellular signals may not penetrate buildings as well. However, accurate user location depends on accurate WiFi AP location determination. Obtaining the accurate locations of the WiFi APs is usually costly because time consuming measurements are required. Example embodiments disclosed address the positioning problem where GPS may be unavailable or partially available.

Example systems, methods and devices disclosed herein can progressively determine AP positions. According to one or more example embodiments, AP location can be obtained from a mobile device with GPS using WiFi-ranging measurement at three or more locations. With the obtained information, the AP network may be able to bootstrap and estimate locations of all APs. In cases where GPS location information may not be available, example systems, methods and devices can determine the relative location of all APs, which may be used to determine the relative position of a mobile user. Example systems, methods and devices use WiFi ranging capability to provide a better user experience, and helps commercial building owners to easily determine locations of WiFi APs installed in their building.

Details of one or more implementations are set forth in the accompanying drawings and in the description below. Further embodiments, features, and aspects will become apparent from the description, the drawings, and the claims.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The terms “communication station”, “station”, “handheld device”, “mobile device”, “wireless device” and “user equipment” (UE), as used herein, refer to a wireless communication device such as a cellular telephone, smartphone, tablet, netbook, wireless terminal, laptop computer, a wearable computer device, a femtocell, High Data Rate (HDR) subscriber station, access point, access terminal, or other personal communication system (PCS) device. The device may be either mobile or stationary.

The term “access point” (AP) as used herein may be a fixed station or another mobile station. An access point may also be referred to as an access node, a base station or some other similar terminology known in the art. An access point may also be called a mobile station, a user equipment (UE), a wireless communication device or some other similar terminology known in the art. Both communication station and the access point may simply be referred to as a device in the present disclosure. Embodiments disclosed herein generally pertain to wireless networks. Some embodiments can relate to wireless networks that operate in accordance with one of the IEEE 802.11 standards including the IEEE 802.1 lax standard.

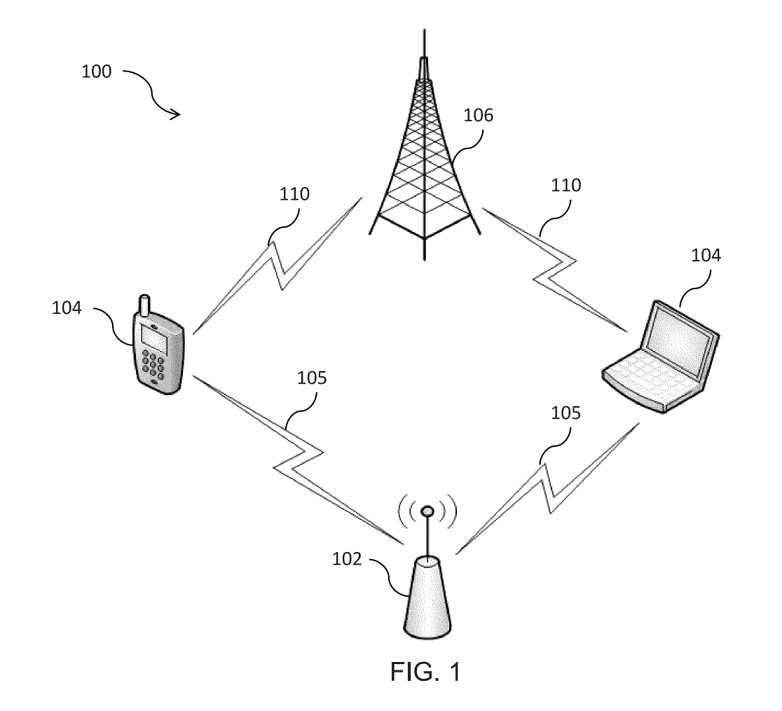

FIG. 1 is a network diagram illustrating an example network environment suitable for FTM Burst Management, according to some example embodiments. Wireless network 100 can include one or more communication stations (STAs) 104 and one or more access points (APs) 102, which may communicate in accordance with IEEE 802.11 communication techniques via communication link 105, for example. The communication stations 104 may be mobile devices that are non-stationary and do not have fixed locations. The one or more APs may be stationary and have fixed locations. The stations may include an AP communication station (AP) 102 and one or more responding communication stations STAs 104. Network 100 may also include one or more communication towers 106, such as for example a cellular tower, which may communicate with the one or more communication stations 104 through a cellular network connection 110, such as for example a 2G, 3G, 4G, or 4G LTE, or any other cellular network connection.

In accordance with some IEEE 802.11ax (High-Efficiency Wi-Fi (HEW)) embodiments, an access point may operate as a master station which may be arranged to contend for a wireless medium (e.g., during a contention period) to receive exclusive control of the medium for an HEW control period (i.e., a transmission opportunity (TXOP)). The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

The master station may also communicate with legacy stations in accordance with legacy IEEE 802.11 communication techniques. In some embodiments, the master station may also be configurable communicate with HEW stations outside the HEW control period in accordance with legacy IEEE 802.11 communication techniques, although this is not a requirement.

In other embodiments, the links of an HEW frame may be configurable to have the same bandwidth and the bandwidth may be one of 20 MHz, 40 MHz, or 80 MHz contiguous bandwidths or an 80+80 MHz (160 MHz) non-contiguous bandwidth. In certain embodiments, a 320 MHz contiguous bandwidth may be used. In other embodiments, bandwidths of 5 MHz and/or 10 MHz may also be used. In these embodiments, each link of an HEW frame may be configured for transmitting a number of spatial streams, for example.

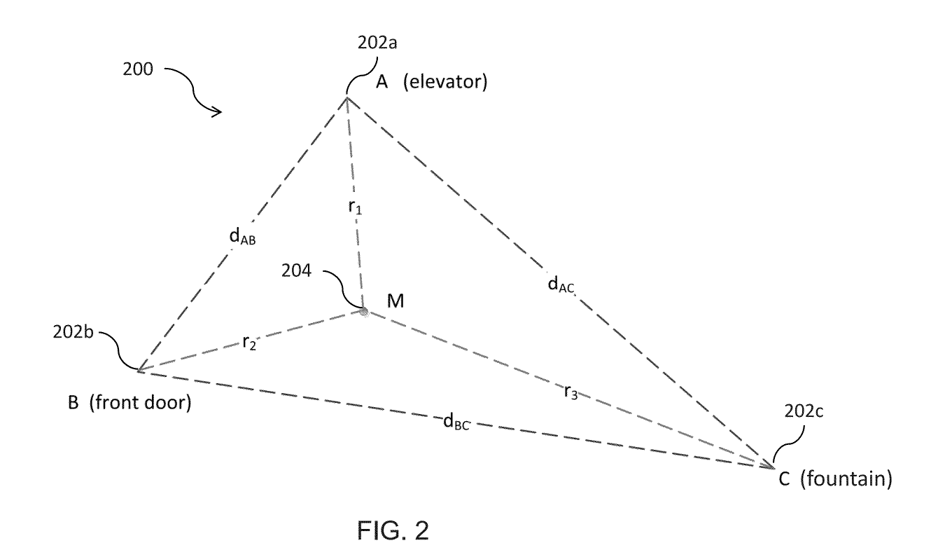

Turning now to FIG. 2, illustrated is an example wireless network 200, such as for example a WLAN or Wi-Fi network, including a plurality of network elements 202a, 202b, 202c, and 204. Network elements 202a, 202b, 202c may be wireless access points (APs) that may communicate with each other as well as one or more mobile devices 204. APs 202a, 202b, 202c may be installed at various locations in a building, such as for example, at or near the elevator A, at or near the front door or entrance B, at or near a landmark in the building, such as for example, a fountain C. Each of these APs may be installed at landmark locations within the building, which may be easily identifiable using a floor plan of the building or using information that may be obtained from the owner or management of the building.

According to one or more example embodiments, a mobile device 204 may conduct at least three ranging measurements r₁, r₂, r₃ with the three anchor devices, APs 202a, 202b, and 202c, to determine its position relative to the APs. In order to determine its precise location indoor, however, mobile device 204 may need to know the GPS positions of the three anchor devices 202a, 202b, and 202c. Since GPS signal may be usually unavailable indoors, the mobile device 204 can determine its relative position and orientation with respect to the three anchor devices 202a, 202b, and 202c as long as the distances between the three anchor devices 202a, 202b, and 202c are known. Since the landmark network elements or APs 202a, 202b, 202c may be plotted in a two dimensional space, and may be connected to form a triangle, once the mobile device knows the edge lengths d_{AB}, d_{AC}, d_{BC} of the triangle and the distances to the three vertexes r₁, r₂, r₃, the mobile device may be able to locate its position with respect to the vertices A, B, C.

Since GPS signal may be available at the outer part of the building, a mobile user 104 with GPS signal can help the WiFi access points (APs) 102 at the outer part of the building to obtain their positions. The outer APs 102 can further utilize the obtained positions to help the inner APs 102 to get their positions. Similarly, APs all over the building obtain their positions such that they can provide positioning service to the mobile users 104 in the building, for example. According to one or more example embodiments, Wi-Fi ranging techniques or ultrasound ranging may be used by mobile device 104 to determine the distance between the mobile device 104 and one or more APs 102, for example.

The minimum signal delay error for any Wi-Fi system may be the sampling period used in the physical (PHY) layer. Earlier Wi-Fi systems were not able to provide an accurate measurement of distance using signal delays due to their longer sampling period. For example, in a Wi-Fi system using 20 MHz channels, the minimum delay measurement error may be on the order of 0.05 μs. This may translate to a distance measurement error of 15 meters. However, with newer Wi-Fi systems using 80 MHz, such as for example IEEE 802.11ac or later, the sampling period is much shorter at 0.0125 μs. This translates to a distance measurement error on the order of 3.75 m, which is significantly lower than the earlier systems. Similarly, for Wi-Fi systems using even wider channels they may experience much smaller distance measurement errors. Using ultrasound ranging technique, for example, the accuracy can be even higher, for example up to a few inches.

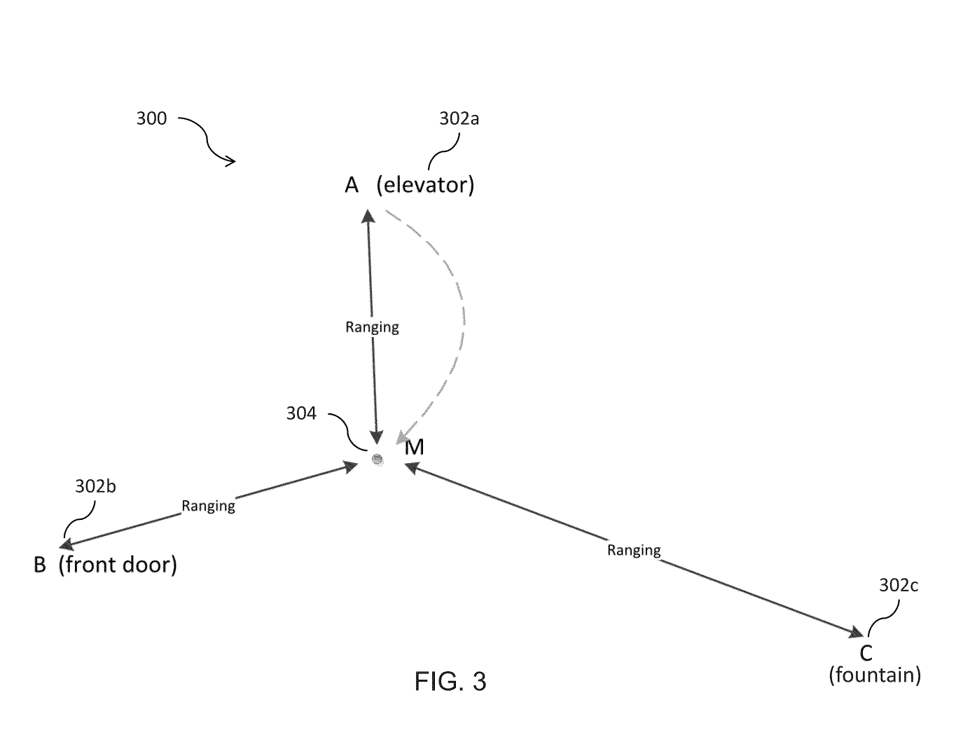

FIG. 3 illustrates an indoor Wi-Fi network 300 where a mobile device 304 is able to determine its position without GPS information, for example. When GPS is not available, mobile device 304 can find its location and orientation with respect to landmarks inside the building using one or more example embodiments disclosed. For example, a mobile device M/304 may want to locate its relative position with respect to three landmarks A, B, and C inside a building as shown in FIG. 3. Each landmark may have a Wi-Fi device such as APs 302a, 302b, and 302c. Although device M can measure its distance to the three landmarks A, B, and C using Wi-Fi ranging or ultrasound ranging, device M may not be able to locate its position and orientation with respect to A, B, and C. However, if distances among A, B, and C are known to device M, then device M may be able to locate its position and/or orientation with respect to points A, B, and C. This may need APs 302a, 302b, and 302c at points A, B, C sending additional distance information to ranging device M/304 in addition to a ranging response.

According to one or more example embodiments, the position of mobile device 304 can be computed either at the mobile device 304 or the anchor device(s) 302. If the position is computed at the mobile device 304, then the mobile device may need to know its distances to the anchors 302a, 302b, and 302c and the distances between the anchors 302a, 302b, and 302c. The anchor devices 302a, 302b, and 302c may send the mobile device 304 the distances between anchor devices and/or a map including locations of nearby anchor devices. Furthermore, in order for the mobile device 304 to identify the landmark, for example an elevator, a front door or entrance, or a fountain, by the anchor device 302, the anchor device 302 can send the mobile device 304 the description of the landmark, such as for example meta data including this information and/or a picture of the front door. Application software on the mobile device 304 may aggregate the two pieces of information including other sensor information at the mobile device 304 such as direction information from a compass and accelerometer. A navigation graphical user interface (GUI) may then show the mobile user its position and orientation, for example. If the position is computed at the infrastructure, for example an anchor device 302, the distances from the mobile device 304 to multiple anchor devices 302a, 302b, and 302c may need to be collected by the infrastructure together with the between among the anchor devices 302a, 302b, and 302c. The computed position and map may be sent to the mobile device 304 for viewing by the user, for example.

According to one or more example embodiments, low cost positioning of the anchor APs may be enabled. Anchor APs 302a, 302b, and 302c can be generalized to any device with GPS and WiFi capability, for example. As long as the device is capable of ranging and has GPS information, it can help other devices determine their positions as well.

According to one example embodiment, some devices in the environment may have GPS but others might not. The ones with GPS can offer ranging response to another device by polling other devices for computing its location. The device with GPS can respond to the ranging poll or request from another device and provide its GPS information so that the polling device can compute its location after one or more polls. For example, on one floor some phones at the outer location may have GPS signals but the inner ones may not. In such an instance, the outer phone can help the inner phone determine its position using Wi-Fi ranging.

According to another example embodiment, GPS may be available around the building, and a mobile device such as cell phone with GPS and Wi-Fi may conduct ranging measurements with the APs inside the building. The position of a Wi-Fi AP inside the building can be determined using ranging measurements with one or more mobile devices at known positions. After the positions of the APs close to the exterior of the building are obtained, the positions of the interior APs, which cannot conduct Wi-Fi ranging with the mobile device, can be obtained by conducting ranging measurements with the APs with known positions. Namely, the positioning of AP propagates from the exterior to the interior of the building, for example.

According to another example embodiment, when GPS is unavailable around the building, the APs may still be able to obtain relative positions with respect to themselves. This may be sufficient for indoor positioning since the client may only need a relative position with respect to the interior landmarks of the building, such as the elevator. The position of each AP can include three coordinates or position parameters, for example x, y, z or r, theta, gamma. The AP can conduct ranging measurement with other APs using Wi-Fi ranging, for example. The distances between APs can go up quadratically with N, for example (N−1)*N/2, where N may be the number of APs. However, the number of unknown parameters can go up linearly with N, for example 3N. As such, there may be only 3(N−1) parameters in any situation. Therefore, one has (N−1)*N/2 distance equations to solve for 3(N−1) unknown AP locations. Since there are more equations than unknowns, the AP positions can be obtained easily. The obtained positions of the APs can be further be mapped to GPS coordinates when GPS locations of three of the APs are obtained.

Example systems, methods, and devices disclosed can solve the problem of determining the locations of all Wi-Fi APs in a Wi-Fi network deployed in large commercial buildings without constraining installers to precisely install each Wi-Fi AP to accurately measured locations. In addition, as Wi-Fi APs are installed and taken down, it may be difficult to keep track of all the locations of the new/updated APs. Example systems, methods, and devices disclosed eliminate the logistics for humans to keep track of all Wi-Fi AP locations and automate this process instead.

According to one example embodiment, if an AP needs to determine its position, it may do so by conducting ranging measurements with other devices at three distinct positions with known position parameters or coordinates. For example, an AP under positioning may conduct Wi-Fi ranging with a cell phone while the cell phone user is moving outside the building, for example. The cell phone may not only conduct Wi-Fi ranging but also send its GPS position to the AP. Besides mobile devices, Wi-Fi APs with known positions can also be used for determining the position of another AP. As such, from building blue prints, installers need accurately measure the location of only three installed Wi-Fi APs to enable indoor positioning, according to one example embodiment. A mobile device acting as Wi-Fi AP can be used to determine three or more Wi-Fi AP locations in the wireless network.

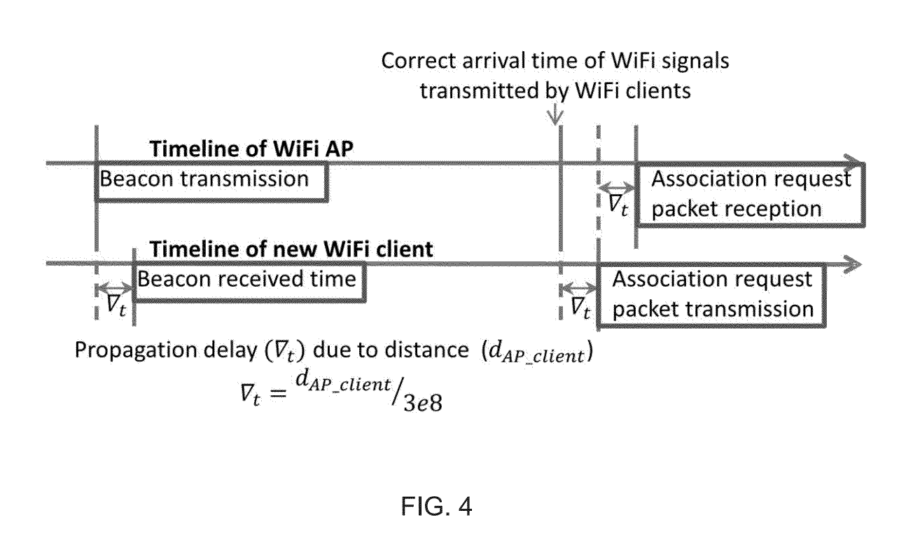

According to one example embodiment, automatic location identification for all other APs in the Wi-Fi network can be carried out using one or more example methods illustrated in FIG. 4. In large commercial buildings, Wi-Fi APs are installed close together where each AP can hear several other APs, for example. For a Wi-Fi AP with known location, a vendor specific field that contains its location in X, Y, Z coordinates can be inserted in its beacon broadcast, for example. To reduce the system overhead, this location information can be broadcasted for example every four or more beacon intervals. For any Wi-Fi AP that needs to know its location, the AP can be set to be in its location determination mode. In this mode, the AP may perform the following operations with at least three Wi-Fi APs with known location information two or more times to increase measurement accuracy. In a first step, the AP may lock onto a beacon signal transmitted by another Wi-Fi AP with location information as shown in FIG. 4. Due to the distance between the stations, the beacon signal may arrive at the client with a time delay ∇t as illustrated in FIG. 4. Next, the AP may send an association packet to the AP starting at the appropriate time. However, this signal may arrive at the AP with a time delay of 2∇t with respect to the clock at the AP. The client may use its beacon reception time as its time reference which is already late by ∇t. When the client sends a signal to the AP, the propagation delay may cause another time delay ∇t as the signal travels from the client to the AP.

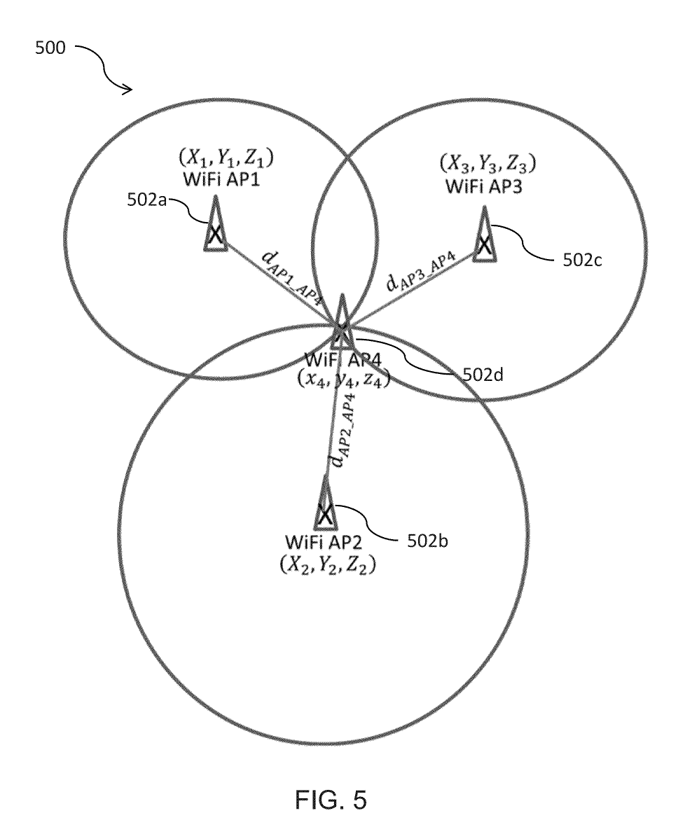

Turning now to FIG. 5, illustrated is an example Wi-Fi network 500 including four Wi-Fi APs, for example. The locations of Wi-Fi AP1 (502a), AP2 (502b), and AP3 (502c) may be known and denoted as (X₁, Y₁, Z₁), (X₂, Y₂, Z₂), and (X₃, Y₃, Z₃) respectively. It should be noted however that Wi-Fi AP1, AP2 and AP3 can be Wi-Fi APs or they can be a mobile phone setup as Wi-Fi APs in three different locations within the building. The location (X₄, Y₄, Z₄) of Wi-Fi AP4 (502d) may be determined using the least squared method using the coordinates of the other three APs, according to one or more example embodiments. From FIG. 5, the following set of equations can be deduced using vector distance formula, for example.

d_{AP1}_{_}_{AP4}²=(X₁−x₄)²+(Y₁−y₄)²+(Z₁−z₄)², ∇ₜ₁_{_}₄=d_{AP1}_{_}_{AP4}/3e8, d_{AP1}_{_}_{AP4}²=∇ₜ₁_{_}₄²*9e16

d_{AP2}_{_}_{AP4}²=(X₂−x₄)²+(Y₂−y₄)²+(Z₂−z₄)², ∇ₜ₂_{_}₄=d_{AP2}_{_}_{AP4}/3e8, d_{AP2}_{_}_{AP4}²=∇ₜ₂_{_}₄²*9e16

d_{AP3}_{_}_{AP4}²=(X₃−x₄)²+(Y₃−y₄)²+(Z₃−z₄)², ∇ₜ₃_{_}₄=d_{AP3}_{_}_{AP4}/3e8, d_{AP3}_{_}_{AP4}²=∇ₜ₃_{_}₄²*9e16

Where d_{AP1}_{_}_{AP4} is the distance between AP1 and AP4, d_{AP2}_{_}_{AP4} is the distance between AP2 and AP4, and d_{AP3}_{_}_{AP4} is the distance between AP3 and AP4. Similarly, ∇t₁_{_}₄ is the propagation delay between AP1 and AP4 due to distance d_{AP1}_{_}_{AP4}, ∇t₂_{_}₄ is the propagation delay between AP2 and AP4 due to distance d_{AP2}_{_}_{AP4}, and ∇t₃_{_}₄ is the propagation delay between AP3 and AP4 due to distance d_{AP3}_{_}_{AP4}. In vector form, this may be represented as

$$( \begin{matrix}2 {X}_{2} - 2 {X}_{1} & 2 {Y}_{2} - 2 {Y}_{1} & 2 {Z}_{2} - 2 {Z}_{1} \\ 2 {X}_{3} - 2 {X}_{2} & 2 {Y}_{3} - 2 {Y}_{2} & 2 {Z}_{3} - 2 {Z}_{2} \\ 2 {X}_{1} - 2 {X}_{3} & 2 {Y}_{1} - 2 {Y}_{3} & 2 {Z}_{1} - 2 {Z}_{3}\end{matrix} ) ( \begin{matrix}{x}_{4} \\ {y}_{4} \\ {z}_{4}\end{matrix} ) = ( \begin{matrix}{∇}_{t 1 \_ 4}^{2} * 9 e 16 - {∇}_{t 2 \_ 4}^{2} * 9 e 16 - {X}_{1}^{2} + {X}_{2}^{2} - {Y}_{1}^{2} + {Y}_{2}^{2} - {Z}_{1}^{2} + {Z}_{2}^{2} \\ {∇}_{t 2 \_ 4}^{2} * 9 e 16 - {∇}_{t 3 \_ 4}^{2} * 9 e 16 - {X}_{2}^{2} + {X}_{3}^{2} - {Y}_{2}^{2} + {Y}_{3}^{2} - {Z}_{2}^{2} + {Z}_{3}^{2} \\ {∇}_{t 3 \_ 4}^{2} * 9 e 16 - {∇}_{t 1 \_ 4}^{2} * 9 e 16 - {X}_{3}^{2} + {X}_{1}^{2} - {Y}_{3}^{2} + {Y}_{1}^{2} - {Z}_{3}^{2} + {Z}_{1}^{2}\end{matrix} )$$

To increase measurement accuracy, either information obtained from more than three Wi-Fi APs may be used or delay measurements may be performed multiple times. The unknown coordinates of Wi-Fi AP4 can thus be solved as

$$A ( \begin{matrix}{x}_{4} \\ {y}_{4} \\ {z}_{4}\end{matrix} ) = b \\ ( \begin{matrix}{x}_{4} \\ {y}_{4} \\ {z}_{4}\end{matrix} ) = {( {A}^{T} A )}^{- 1} {A}^{T} b .$$

The measured noise and interference are, however, ignored in the equations above for the sake of simplicity.

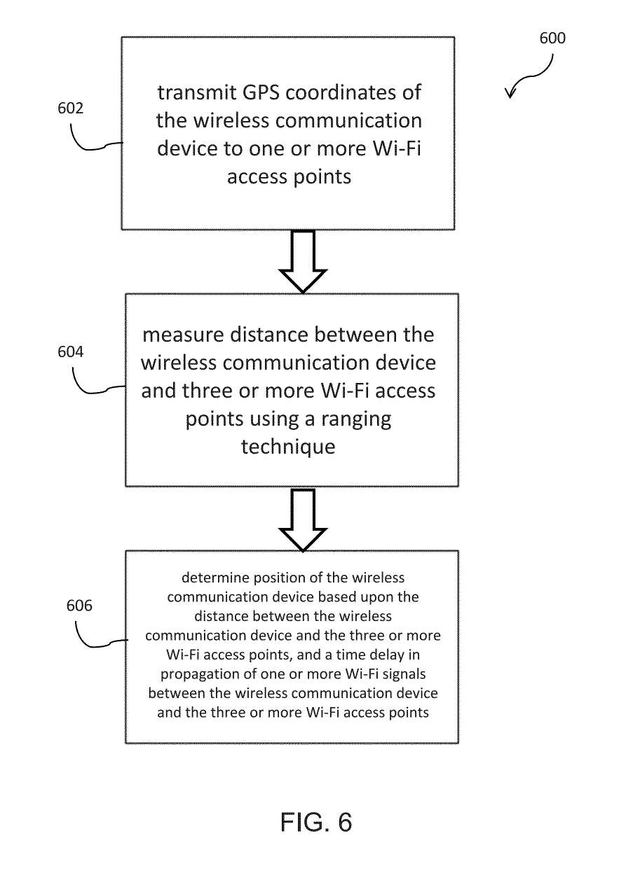

FIG. 6 illustrates example operations in a method 600 for determining indoor location of a wireless communication device, according to one or more example embodiments. In step 602, for example, the wireless communication device may transmit its GPS coordinates to one or more Wi-Fi access points. In step 604, the wireless communication device may measure distance between the wireless communication device and three or more Wi-Fi access points using a ranging technique, for example. In step 606, the wireless communication device may determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device may be computed using least squared method as described in the above embodiments.

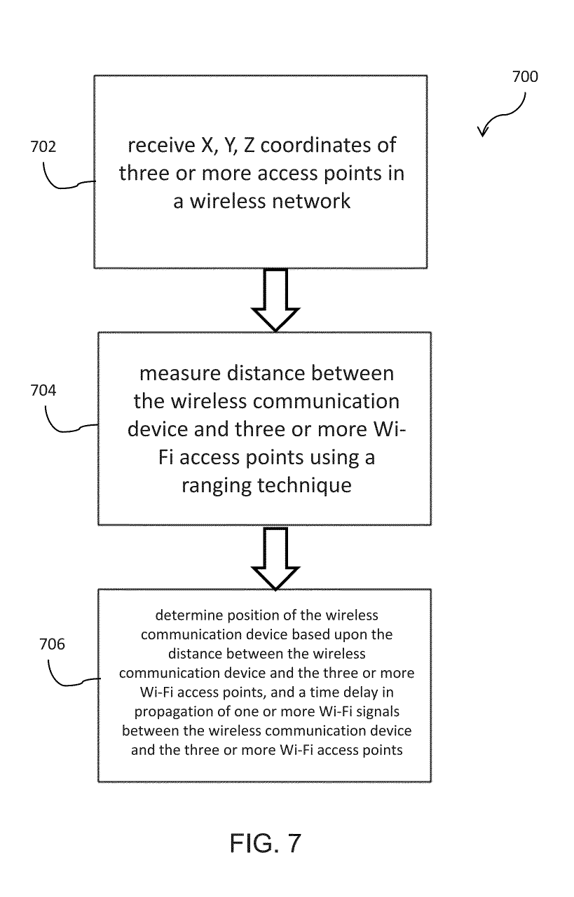

FIG. 7 illustrates example operations in a further method 700 for determining indoor location of a wireless communication device, according to one or more example embodiments. For example, in step 702 the wireless communication device may receive X, Y, Z coordinates of three or more access points in a wireless network. In step 704, the wireless communication device may measure distance between the wireless communication device and three or more Wi-Fi access points using a ranging technique, for example. In step 706, the wireless communication device may determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device may be computed using least squared method, as described in the above embodiments, for example.

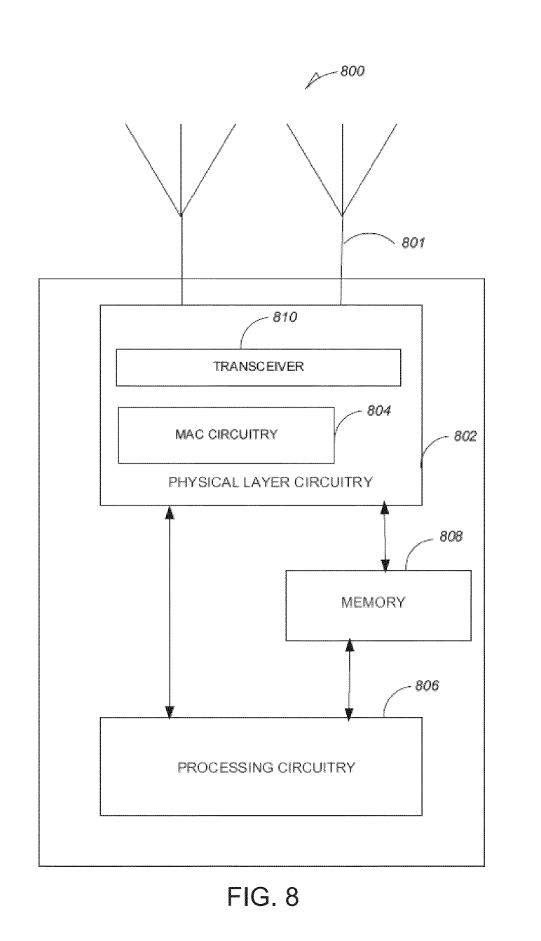

FIG. 8 shows a functional diagram of an exemplary communication station 800 in accordance with some embodiments. In one embodiment, FIG. 8 illustrates a functional block diagram of a communication station that may be suitable for use as an AP 102 (FIG. 1) or communication station STA 104 (FIG. 1) in accordance with some embodiments. The communication station 800 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 800 may include physical layer circuitry 802 having a transceiver 810 for transmitting and receiving signals to and from other communication stations using one or more antennas 801. The physical layer circuitry 802 may also include medium access control (MAC) circuitry 804 for controlling access to the wireless medium. The communication station 800 may also include processing circuitry 806 and memory 808 arranged to perform the operations described herein. In some embodiments, the physical layer circuitry 802 and the processing circuitry 806 may be configured to perform operations detailed in FIGS. 1-7.

In accordance with some embodiments, the MAC circuitry 804 may be arranged to contend for a wireless medium and configure frames or packets for communicating over the wireless medium and the physical layer circuitry 802 may be arranged to transmit and receive signals. The physical layer circuitry 802 may include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the physical layer circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device may, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

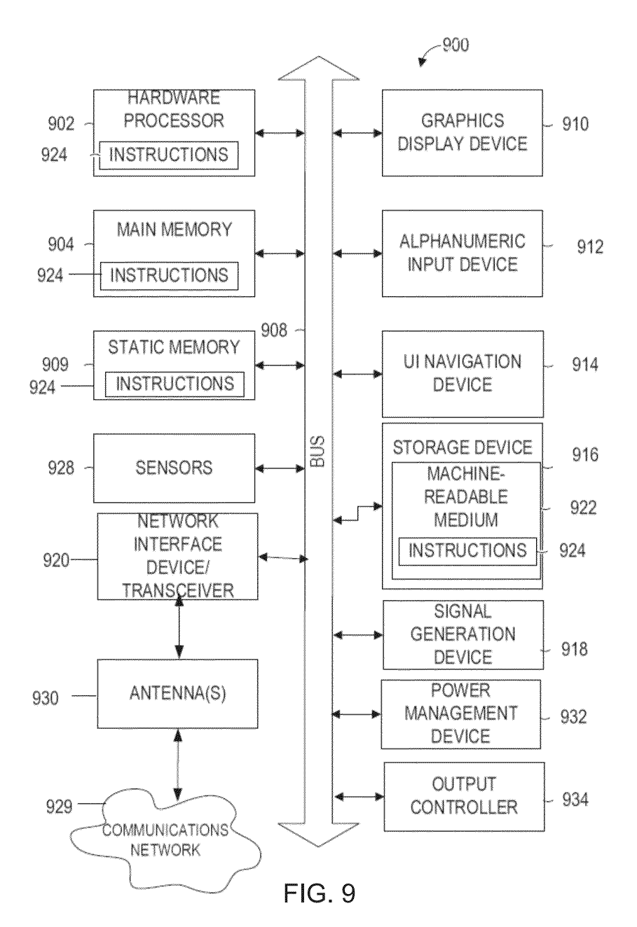

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912 and UI navigation device 914 may be a touch screen display. The machine 900 may additionally include a storage device (i.e., drive unit) 916, a signal generation device 918 (e.g., a speaker), a network interface device/transceiver 920 coupled to antenna(s) 930, and one or more sensors 928, such as a global positioning system (GPS) sensor, compass, accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium includes a machine readable medium with a plurality of particles having resting mass. Specific examples of massed machine readable media may include: non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible media to facilitate communication of such software.

### Example Embodiments

One example embodiment is a wireless communication device including physical layer circuitry, one or more antennas, at least one memory, and one or more processing elements to transmit GPS coordinates of the wireless communication device to one or more Wi-Fi access points, measure distance between the wireless communication device and three or more Wi-Fi access points using a ranging technique, and determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a non-transitory computer readable storage device including instructions stored thereon, which when executed by one or more processor(s) of a wireless communication device, cause the wireless communication device to perform operations of transmitting GPS coordinates of the wireless communication device to one or more Wi-Fi access points, measuring distance between the wireless communication device and three or more Wi-Fi access points using a ranging technique, and determining location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a method for determining indoor location of a wireless communication device, the method including transmitting, by the wireless communication device, GPS coordinates of the wireless communication device to one or more Wi-Fi access points, measuring, by the wireless communication device, distance between the wireless communication device and three or more Wi-Fi access points using a ranging technique, and determining, by the wireless communication device, location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a system including a plurality of access points in communication with a wireless communication device including physical layer circuitry, one or more antennas, at least one memory, and one or more processing elements to transmit GPS coordinates of the wireless communication device to one or more Wi-Fi access points, measure distance between the wireless communication device and three or more Wi-Fi access points using a ranging technique, and determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a wireless communication device including physical layer circuitry, one or more antennas, at least one memory, and one or more processing elements to receive X, Y, Z coordinates of three or more access points in a wireless network, measure distance between the wireless communication device and three or more Wi-Fi access points using a ranging technique, and determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a non-transitory computer readable storage device including instructions stored thereon, which when executed by one or more processor(s) of a wireless communication device, cause the wireless communication device to perform operations of receiving X, Y, Z coordinates of three or more access points in a wireless network, measuring distance between the wireless communication device and three or more Wi-Fi access points using a ranging technique; and determining location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a method for determining indoor location of a wireless communication device, the method including receiving, by the wireless communication device, X, Y, Z coordinates of three or more access points in a wireless network, measuring, by the wireless communication device, distance between the wireless communication device and three or more Wi-Fi access points using a ranging technique, and determining, by the wireless communication device, location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

Another example embodiment is a system including a plurality of access points in communication with a wireless communication device including physical layer circuitry, one or more antennas, at least one memory, and one or more processing elements to receive X, Y, Z coordinates of three or more access points in a wireless network, measure distance between the wireless communication device and three or more Wi-Fi access points using a ranging technique, and determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points. The ranging technique may include Wi-Fi ranging or ultrasound ranging. The location of the wireless communication device is computed using least squared method.

While there have been shown, described and pointed out, fundamental novel features of the exemplary embodiments disclosed herein, it will be understood that various omissions and substitutions and changes in the form and details of devices illustrated, and in their operation, may be made by those skilled in the art without departing from the spirit of the disclosure. Moreover, it is expressly intended that all combinations of those elements and/or method operations, which perform substantially the same function in substantially the same way to achieve the same results, are within the scope of the disclosure. Moreover, it should be recognized that structures and/or elements and/or method operations shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. A wireless communication device comprising:
at least one memory comprising computer-executable instructions stored thereon; and
one or more processing elements to execute the computer-executable instructions to:
transmit GPS coordinates of the wireless communication device to one or more Wi-Fi access points;
measure distance between the wireless communication device and three or more Wi-Fi access points using a ranging technique; and
determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

2. The wireless communication device of claim 1, wherein the ranging technique comprises Wi-Fi ranging or ultrasound ranging.

3. The wireless communication device of claim 1, wherein the location of the wireless communication device is computed using a least squared method.

4. A non-transitory computer readable storage device including instructions stored thereon, which when executed by one or more processor(s) of a wireless communication device, cause the wireless communication device to perform operations of:
transmitting GPS coordinates of the wireless communication device to one or more Wi-Fi access points;
measuring distance between the wireless communication device and three or more Wi-Fi access points using a ranging technique; and
determining location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

5. The device of claim 4, wherein the ranging technique comprises Wi-Fi ranging or ultrasound ranging.

6. The device of claim 4, wherein the location of the wireless communication device is computed using a least squared method.

7. A method comprising:
transmitting, by a wireless communication device, GPS coordinates of the wireless communication device to one or more Wi-Fi access points;
measuring, by the wireless communication device, distance between the wireless communication device and three or more Wi-Fi access points using a ranging technique; and
determining, by the wireless communication device, location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

8. The method of claim 7, wherein the ranging technique comprises Wi-Fi ranging or ultrasound ranging.

9. The method of claim 7, wherein the location of the wireless communication device is computed using a least squared method.

10. A system comprising:
a plurality of access points in communication with a wireless communication device comprising:
at least one memory comprising computer-executable instructions stored thereon; and
one or more processing elements to execute the computer-executable instructions to:
transmit GPS coordinates of the wireless communication device to one or more Wi-Fi access points;
measure distance between the wireless communication device and three or more Wi-Fi access points using a ranging technique; and
determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

11. The system of claim 10, wherein the ranging technique comprises Wi-Fi ranging or ultrasound ranging.

12. The system of claim 10, wherein the location of the wireless communication device is computed using a least squared method.

13. A wireless communication device comprising:
at least one memory comprising computer-executable instructions stored thereon; and
one or more processing elements to execute the computer-executable instructions to:
receive X, Y, Z coordinates of three or more access points in a wireless network;
measure distance between the wireless communication device and three or more Wi-Fi access points using a ranging technique; and
determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

14. The wireless communication device of claim 13, wherein the ranging technique comprises Wi-Fi ranging or ultrasound ranging.

15. The wireless communication device of claim 13, wherein the location of the wireless communication device is computed using a least squared method.

16. A non-transitory computer readable storage device including instructions stored thereon, which when executed by one or more processor(s) of a wireless communication device, cause the wireless communication device to perform operations of:
receiving X, Y, Z coordinates of three or more access points in a wireless network;
measuring distance between the wireless communication device and three or more Wi-Fi access points using a ranging technique; and
determining location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

17. The device of claim 16, wherein the ranging technique comprises Wi-Fi ranging or ultrasound ranging.

18. The device of claim 16, wherein the location of the wireless communication device is computed using a least squared method.

19. A method comprising:
receiving, by a wireless communication device, X, Y, Z coordinates of three or more access points in a wireless network;
measuring, by the wireless communication device, distance between the wireless communication device and three or more Wi-Fi access points using a ranging technique; and
determining, by the wireless communication device, location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

20. The method of claim 19, wherein the ranging technique comprises Wi-Fi ranging or ultrasound ranging.

21. The method of claim 19, wherein the location of the wireless communication device is computed using a least squared method.

22. A system comprising:
a plurality of access points in communication with a wireless communication device comprising:
at least one memory comprising computer-executable instructions stored thereon; and
one or more processing elements to execute the computer-executable instructions to:
receive X, Y, Z coordinates of three or more access points in a wireless network;
measure distance between the wireless communication device and three or more Wi-Fi access points using a ranging technique; and
determine location of the wireless communication device based, at least in part, upon the distance between the wireless communication device and the three or more Wi-Fi access points, and a time delay in propagation of one or more Wi-Fi signals between the wireless communication device and the three or more Wi-Fi access points.

23. The system of claim 22, wherein the ranging technique comprises Wi-Fi ranging or ultrasound ranging.

24. The system of claim 22, wherein the location of the wireless communication device is computed using a least squared method.
